(19) United States
(12) Patent Application Publication
(10) Pub. No.: US 2006/0108558 A1
(43) Pub. Date: May 25, 2006

(54) Outlet arrangement

(75) Inventor: Colin Wooldridge, Modbury (AU)

Correspondence Address: MERCHANT & GOULD PC, P.O. BOX 2903, MINNEAPOLIS, MN, 55402-0903, US

(73) Assignee: Caroma Industries Limited, Brisbane (AU)

(21) Appl. No.: 10/528,216

(22) PCT Filed: Aug. 28, 2003
(86) PCT No.: PCT/AU03/01106

§ 371 Date: Oct. 3, 2005

(30) Foreign Application Priority Data
Sep. 19, 2002 (AU) 2002951508

(51) Int. Cl. F16K 31/00

(52) U.S. Cl. 251/344

(57) ABSTRACT

An outlet arrangement (10) for adapting a water receptacle (40b) having a smaller diameter outlet for use with a larger diameter waste outlet and trap. The arrangement (10) includes an outlet member (16) and a locking collar (12). The outlet member (16) has a first end (20) adapted to seal against an opening (46) of either the smaller or the larger diameter and a second threaded end (28) adapted to fit through an opening (42) of the smaller diameter. The locking collar (12) has an internal thread (32) adapted to engage with the second threaded end (28) of the outlet member (16) and an external thread (34) adapted to engage a waste outlet or trap of the larger diameter.

### TECHNICAL FIELD

The present invention relates to an outlet arrangement for adapting a water receptacle having a smaller diameter outlet for use with a larger diameter waste outlet and trap.

The invention has been primarily developed to adapt sinks or hand basins produced with outlet openings suited for 32 mm diameter waste outlet components for use with 40 mm diameter traps and will be described hereinafter with reference to this application. However, it will be appreciated that the invention is not limited to these particular use and is equally suited for relatively smaller and larger diameters of various sizes.

### BACKGROUND OF THE INVENTION

Water receptacles, such as sinks and hand basins, produced for markets outside of Australia commonly have an outlet opening designed to fit 32 mm waste outlet components. Sinks and hand basins produced for the Australian market have an outlet opening designed to fit 40 mm diameter waste outlet components, which are suitable for connection to the 40 mm diameter traps common in Australian plumbing. Accordingly, adapting 32 mm waste outlet components to 40 mm plumbing requires a 32 mm to 40 mm thread adaptor.

There are two main disadvantages associated with such thread adaptors. The first is that they represent an additional expense to produce, supply and install. The second is they introduce an extra potential leak path between the waste outlet in the sink/basin and the adaptor.

### OBJECT OF THE INVENTION

It is the object of the present invention to substantially overcome or at least ameliorate one or more of the above prior art disadvantages.

### SUMMARY OF THE INVENTION

Accordingly, the present invention provides an outlet arrangement for adapting a water receptacle having a smaller diameter outlet for use with a larger diameter waste outlet and trap, the arrangement including;

an outlet member having a first end adapted to seal against an outlet opening of either the smaller or the larger diameter in an inner side of the water receptacle, a second threaded cylindrical end adapted to fit through an opening of the smaller diameter and at least one radial opening in the second threaded end; and

a locking collar having an internal thread adapted to engage with the second threaded end of the outlet member, and adapted for screwing along the outlet member second threaded end into abutment with an outer side of the water receptacle, and an external thread adapted to engage a waste outlet or trap of the larger diameter.

The outlet member first end preferably includes a sealing region adapted to seal against a waste outlet opening of either the smaller or the larger diameter. The outlet member first end sealing region is preferably in the form of an annular flange.

The collar preferably includes a sealing region adapted to seal against the outer side of the water receptacle adjacent the waste outlet. The collar sealing region is preferably in the form of an external annular flange. The external annular flange preferably has an inner diameter smaller, most preferably only slightly smaller, than the smaller diameter and an outer diameter larger than the larger diameter. The collar sealing region is preferably nearer the opposite end of the collar to that having the external thread.

The outlet arrangement is preferably sized to adapt a sink or basin with an outlet opening suitable for 32 mm diameter outlet components for use with a 40 mm diameter waste outlet and trap.

### BRIEF DESCRIPTION OF THE DRAWINGS

A preferred embodiment of the invention will now be described, by way of example only, with reference to the accompanying drawings in which:

FIG. 1 is an exploded perspective view of a first embodiment of an outlet arrangement according to the invention;

FIG. 2 is a cross sectional side view of the outlet arrangement shown in FIG. 1 installed in a non-overflow basin suited for 40 mm waste outlet components;

FIG. 3 is a cross sectional side view of the outlet arrangement shown in FIG. 1 installed in an overflow basin suited for 32 mm waste outlet components; and

FIGS. 4 to 8 are assembled top, perspective, side, front and cross sectional side views respectively of the outlet arrangement shown in FIG. 1.

### DETAILED DESCRIPTION OF THE PREFERRED EMBODIMENT

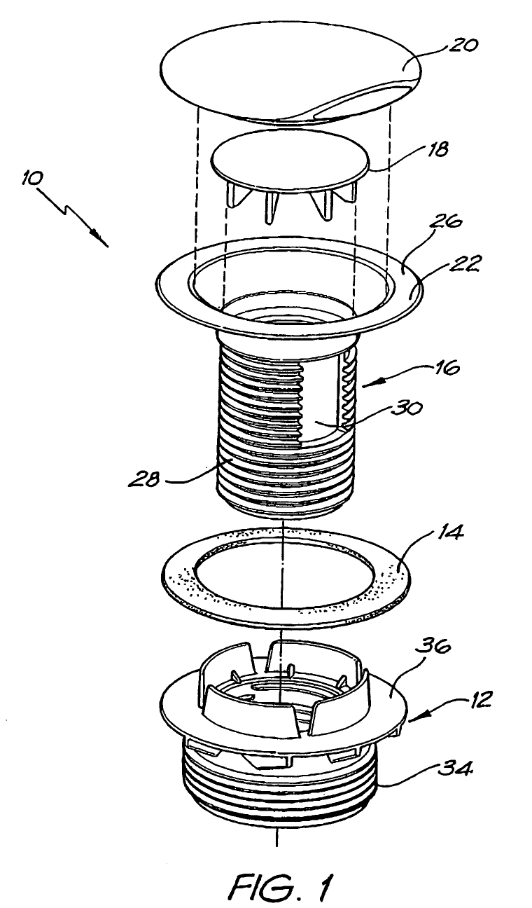

Referring firstly to FIG. 1, there is shown a exploded perspective view of an embodiment of an outlet arrangement 10 according to the invention. The arrangement 10 includes a locking collar 12, an annular rubber washer/seal 14, an outlet member 16, a grate 18 and a plug 20. The locking collar 12, outlet member 16 and grate 18 are preferably moulded from a thermoplastic material, most preferably polypropylene.

The outlet member has a first end 22 that has an annular flange 26 which, as will be explained in more detail below, is adapted to seal against waste outlet openings of 32 and 40 mm in diameter respectively. The outlet member 16 also has a second threaded end 28 which, in the preferred form shown, includes a pair of overflow openings 30.

The locking collar 12 has an internal thread 32 (best seen in FIG. 8) which is sized to engage with the threaded end 28 of the outlet member 16. The locking collar 12 also has an external thread 34 which is sized to engage with plumbing fittings associated with 40 mm diameter waste outlets and traps. The locking collar 12 also has an annular sealing flange 36, of common size to the washer 14, which, in use, seals against the base of a basin, as will be described in more detail below.

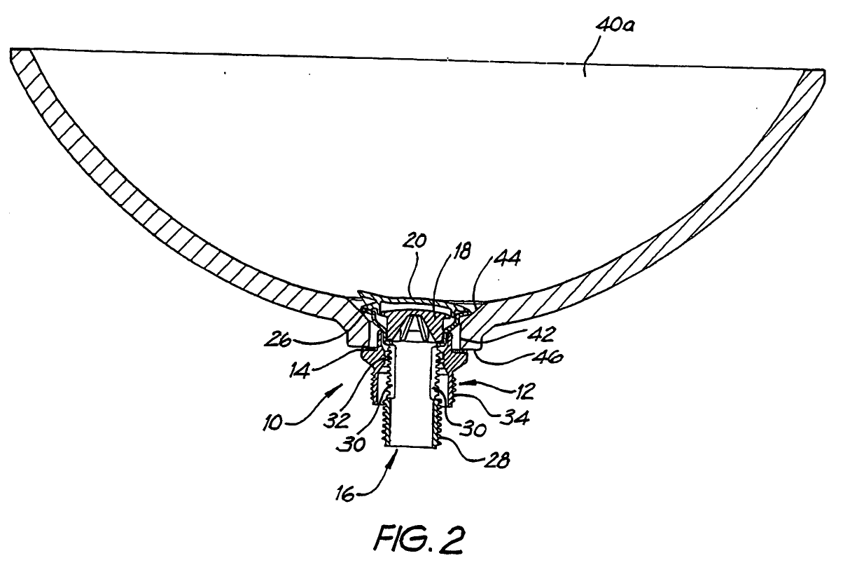

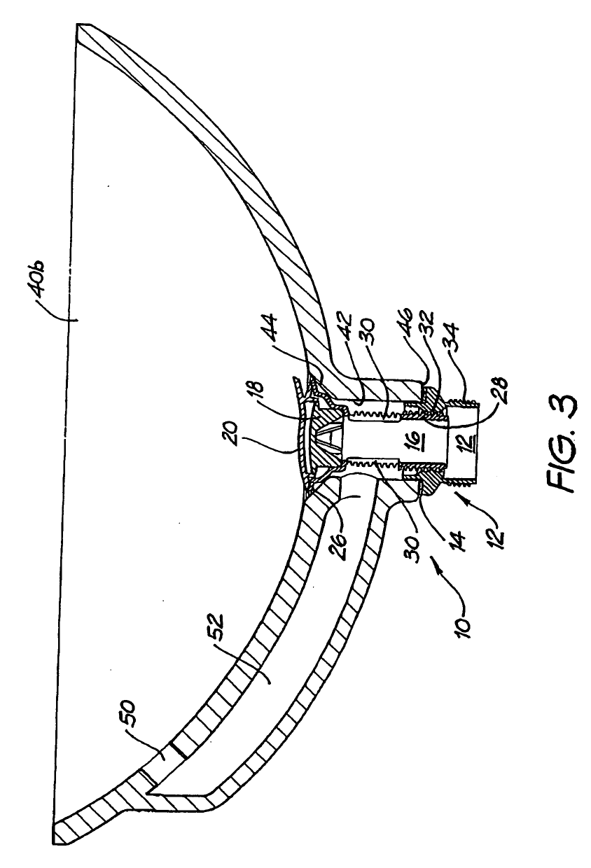

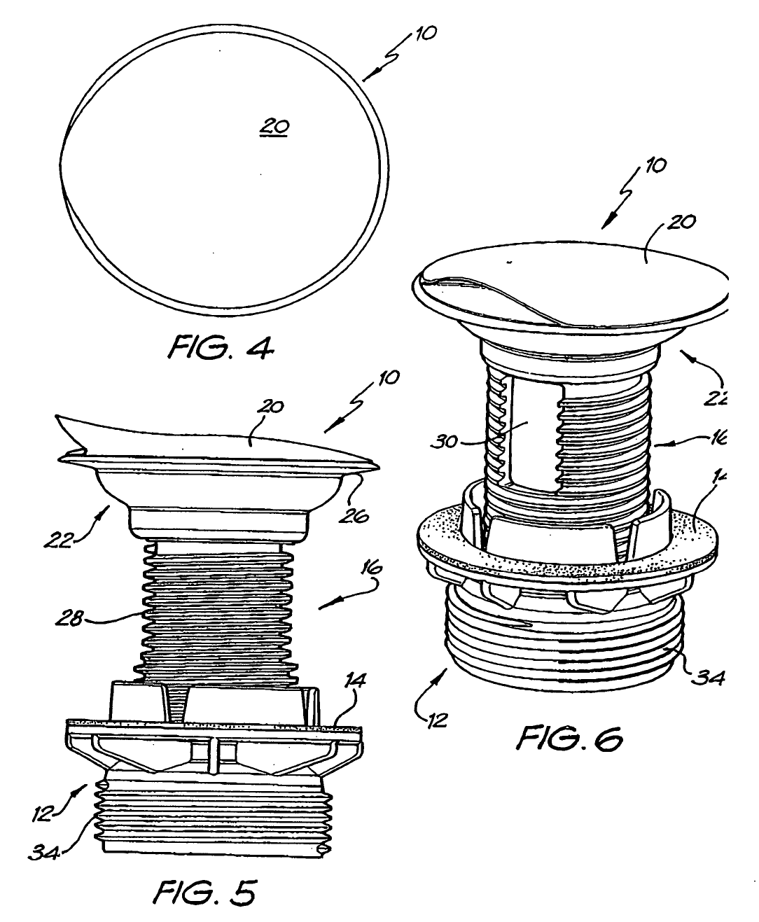

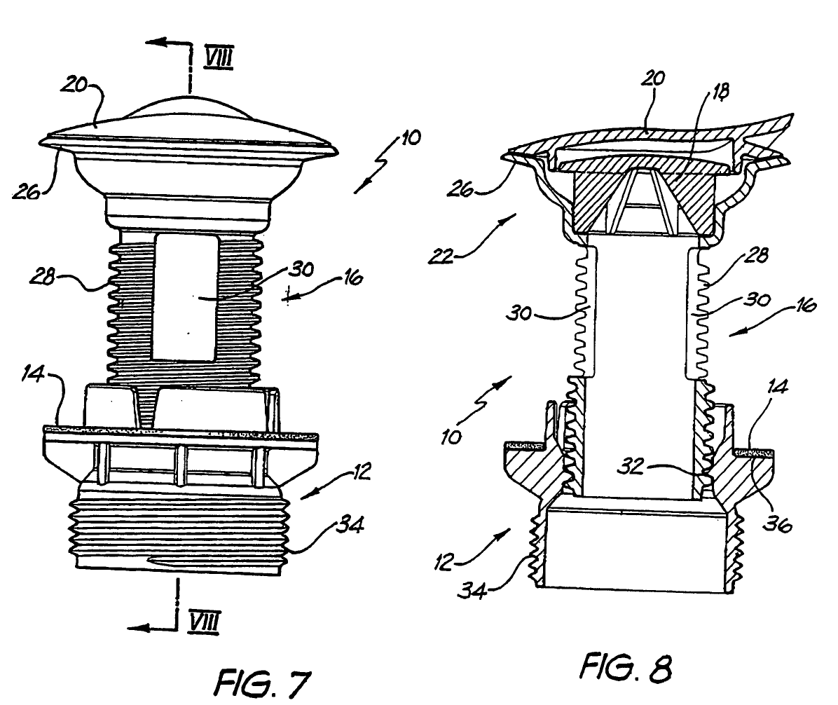

The installation and operation of the outlet arrangement 10 shall now be described. FIG. 2 shows the outlet arrangement 10 installed in a water receptacle, in the form of a basin 40a, which has an outlet 42 suitable for use with standard 40 mm outlet components. The entrance to the outlet 42 is defined by a tapered portion 44. The annular sealing flange 26 seals against the tapered portion 44 about its outer peripheral edge. Silicone is usually placed between the flange 26 and the tapered portion 44 to enhance the sealing. The locking collar 12 is screwed onto the threaded end 28 of the outlet member until the sealing surface 36 presses the washer 14 into sealing engagement with bottom edge 46 of the outlet 42.

The 40 mm plumbing components (ie. waste outlet and trap) can then be connected to the external thread 34 of the locking collar 12 in the normal manner. It should be noted that the basin 40 is of a standard (ie. non overflow) type and that the overflow openings 30 are not utilised. However, if any leaks occur between the exterior of the outlet member 16 and the interior of the outlet 42, then any leaked fluid can pass through the overflow openings 30 into the waste outlet and trap.

FIG. 3 shows the outlet arrangement installed in another basin 40b having an outlet 42 suitable for use with 32 mm outlet components. Like reference numerals to those used in describing the components shown in FIG. 2 have been used to indicate like features in FIG. 3. In this arrangement, the annular sealing flange 26 of the outlet member 16 again seals (with silicone if necessary) against the tapered portion 44 of the outlet 42. As with the installation previously described, the internal thread 32 of the locking collar 12 engages the threaded end 28 of the outlet member 16 and is screwed therealong until the sealing flange 36 presses the washer 14 into sealing engagement with the bottom edge 46 of the outlet 42. Once again, the external thread 34 of the locking collar 12 is exposed for connection to a 40 mm diameter waste outlet and trap. It should also be noted that the sink 40b is of an overflow type and has an overflow opening 50 and an overflow passage 52. Any fluid that reaches the opening 50 travels via the passage 52 and through the overflow openings 30 and so to the waste outlet and trap.

The outlet arrangement described above has several advantages over existing arrangements. Firstly, the arrangement provides a single set of components which are suitable for use with 32 mm and 40 mm outlet sinks thereby reducing inventory and production costs.

Secondly, the entire length of the external thread of the locking collar is available for connection to the waste outlet and trap. This is in contrast to some prior art arrangements in which the length of available thread is dependent upon the thickness of the basin outlet or locking collar.

Thirdly, when installing a waste, a plumber must seal with silicone around the top rim of wastes to trap water into the basin. In prior art arrangements, if the silicone is neglected or the seal is broken, water can leak onto the floor or into a bathroom cabinet. However, with the outlet arrangements described above, any leak between the first end of the outlet member and the waste outlet opening in the basin, will be directed into the waste outlet and trap via the overflow holes. This is also the case with overflow basins where, in prior art arrangements, a plumber must seal the thread of the standard 40 mm waste or else water may leak through the thread interface. In the arrangement described above, any such leaking water will again be directed into the waste outlet and trap. A farther advantage is that one model of outlet member can be used with standard and overflow basins, which again reduces inventory and production costs.

It is also possible to produce the outlet member without waste openings as they can be easily produced by plumber (eg. by drilling) when required.

Although the invention has been described with reference to a preferred embodiment, it will also be appreciated that the invention may be embodied in many other forms.

1. An outlet arrangement for adapting a water receptacle having a smaller diameter outlet for use with a larger diameter waste outlet and trap, the arrangement including:
an outlet member having a first end adapted to seal against an outlet opening of either the smaller or the larger diameter in an inner side of the water receptacle, a second threaded cylindrical end adapted to fit through an opening of the smaller diameter and at least one radial opening in the second threaded end; and a locking collar having an internal thread adapted to engage with the second threaded end of the outlet member, and adapted for screwing along the outlet member second threaded end into abutment with an outer side of the water receptacle, and an external thread adapted to engage a waste outlet or trap of the larger diameter.

2. The arrangement as claimed in claim 1, wherein the outlet member first end includes a sealing region adapted to seal against a waste outlet opening of either the smaller or the larger diameter.

3. The arrangement as claimed in claim 2, wherein the outlet member first end sealing region is in the form of an annular flange.

4. The arrangement as claimed in claim 1, wherein the collar includes a sealing region adapted to seal against the outer side of the water receptacle adjacent the waste outlet.

5. The arrangement as claimed in claim 4, wherein the collar sealing region is in the form of an external annular flange.

6. The arrangement as claimed in claim 5, wherein the external annular flange has an inner diameter smaller than the smaller diameter and an outer diameter larger than the larger diameter.

7. The arrangement as claimed in claim 6, wherein the external annular flange has an inner diameter only slightly smaller than the smaller diameter and an outer diameter larger than the larger diameter.

8. The arrangement as claimed in claim 4, wherein the collar sealing region is nearer the opposite end of the collar to that having the external thread.

9. The arrangement as claimed in claim 1, wherein the outlet arrangement is sized to adapt a sink or basin with an outlet opening suitable for use with 32 mm diameter waste outlet components for use with 40 mm diameter waste outlets or traps.
